(19) United States
(12) Patent Application Publication
(10) Pub. No.: US 2020/0328597 A1
(43) Pub. Date: Oct. 15, 2020

(54) DEVICE FOR GENERATING ELECTRICAL ENERGY

(71) Applicant: Jörg Kretschmann, Kempen (DE)

(72) Inventor: Jörg Kretschmann, Kempen (DE)

(73) Assignee: Woodward Kempen GmbH, Kempen (DE)

(21) Appl. No.: 16/849,227

(22) Filed: Apr. 15, 2020

(30) Foreign Application Priority Data
Apr. 15, 2019 (EP) 19169181.5

(51) Int. Cl. H02J 3/36; H02P 9/00; F03D 9/25; H02J 3/38; H02M 7/00; H01F 1/34; H01F 3/14; H02M 1/12

(52) U.S. Cl. CPC H02J 3/36; H02P 9/007; F03D 9/255; H02J 3/381; H02M 2001/0064; H01F 1/34; H01F 3/14; H02M 1/12; H02M 7/003

(57) ABSTRACT

A device for generating electrical energy, in particular a wind turbine, having at least one generator is disclosed. The generator provides electrical energy by means of multi-phase, machine-side connection means and is connected to at least one converter having a DC link via the multi-phase, machine-side connection means. A method for operating a device for generating electrical energy, in particular a wind turbine, is also disclosed. The object of providing a device for generating electrical energy, in particular a wind turbine, which reliably avoids the development of surges despite parasitic inductances and capacitances by means of the machine-side multi-phase connection means is achieved in that means for attenuating at least one series resonance in the zero sequence of the machine-side connection means are provided between generator and converter.

### CROSS-REFERENCE TO RELATED PATENT APPLICATIONS

This patent application claims the benefit of European Patent Application No. 19169181.5, filed Apr. 15, 2019, the entire teachings and disclosure of which are incorporated herein by reference thereto.

### FIELD

The invention relates to a device for generating electrical energy, in particular a wind turbine, having at least one generator, wherein the generator provides electrical energy by means of multi-phase, machine-side connection means and is connected to at least one converter having a DC link by means of the multi-phase, machine-side connection means. The invention further relates to a method for operating a device for generating electrical energy, in particular a wind turbine.

### BACKGROUND

Typical devices for generating electrical energy, for example wind turbines, have a generator which generates the electrical energy, which generator is fed by a further source of energy so it can generate electrical energy. In the case of wind turbines, these are the wind rotors which drive the generator. In the wind turbines used today, the electrical energy is fed into the electrical network via converters. Converters contain circuit breakers which feed the multi-phase, e.g. three-phase alternating current from the generator received from the machine side of the converter into a DC link and generate alternating current adapted to the mains frequency and mains voltage on the network side from this and feed it into the network.

For reasons of space but often also for reasons of safety, generators and converters are generally arranged spatially separate from one another. In wind turbines the space in the gondola in which the generator needs to be arranged is limited, so the converter(s) are often arranged in or on the foot of the wind turbine. This results in long electrical connection paths between the generator and the converter. For the electrical connections, multi-phase connection means are used on the machine-side, which could be implemented either by cables or by busbars. A combination of cables and busbars is often used for the multi-phase, machine-side connection means. For example, the multi-phase, machine-side connection means can initially be designed as a cable route from the generator into the tower of the wind turbine. The cable route can more easily follow the rotation of the gondola. The multi-phase, machine-side connection means are then designed as busbars as these can be easily pre-assembled in the components of the tower so that only the individual components of the tower need to be electrically connected to one another. Further, the multi-phase, machine-side connection means are often guided to the machine-side connection of the converter via cable routes. Due to the geometric structure of cables and busbars, parasitic inductances and capacitances occur, which can lead to unwanted voltage peaks during operation of the device or the wind turbine on the machine-side input of the converter. The voltage peaks occur between the individual phases and the zero potential, wherein the dominant part is formed by the zero sequence. Positive and negative sequences only have a minimal share of these voltage peaks. The terms zero sequence, positive sequence and negative sequence are known to the person skilled in the art as symmetrical component analysis and are not explained in greater detail here.

It is known to avoid this effect of parasitic inductances and capacitanceson the generator side of the converter by means of what are known as dU/dt filters. These generator-side dU/dt filters are, however, usually provided for both the positive, negative and zero sequences with simultaneously significantly lower parasitic inductances and capacitances of the connection means so that these are designed at frequencies in the region of 1 MHz. dU/dt filters are also intended to limit the edge steepness of the voltage to certain levels at low parasitic capacitances and inductances. For this purpose, in many common designs, dU/dt filters have optimized designs with relatively low inductances in the zero sequence so that the surges against the zero potential of the machine-side connection means are generally not affected. Even the selection of a specific control pattern for the individual circuit breakers of the converters, for example by delaying individual switching impulses to counteract the specific voltage jumps, did not lead to a decrease in surges as the surges then occurred for other switching states of the converter. A significant reduction in surges can be achieved by decreasing the parasitic inductances and capacitances of the machine-side connection means. However, as an additional technical requirement of the connection means, this generally leads to increased costs.

Compensating inductive asymmetries between the individual phases of the alternating current system of wind turbines by means of inductive compensation devices is known from patent U.S. Pat. No. 9,500,182 B2. By selecting suitable self-inductance and counter-inductance of the compensation means, the asymmetry of the multi-phase alternating current system of a wind turbine is reduced or compensated. As a result, fluctuating voltages in the DC link of the converters used are avoided and an improved power output with symmetrical flows is achieved. However, the voltage fluctuations measured by the applicant do not lead to a pulsing DC voltage in the DC link of the converter, but rather occur in the zero sequence. This problem is not addressed in the US patent.

Avoiding surges which occur in a battery storage system in the DC bus by providing coupled inductances in the DC system is known from the US American patent application US 2015/0123402 A1. The invention relates, however, to surges in the machine-side alternating voltage system of a device for generating electrical energy or a wind turbine.

### BRIEF SUMMARY

The object of the present invention is therefore to provide a device for generating electrical energy, in particular a wind turbine, which reliably avoids the development of surges despite parasitic inductances and capacitances in the machine-side, multi-phase connection means.

According to the invention, the object of providing a device for generating electrical energy, in particular for a wind turbine, is achieved by means for attenuating at least one, preferably the first series resonance in the zero sequence of the machine-side connection means being provided between the generator and the converter. The first series resonance is preferably attenuated.

From model calculations for the machine-side, multi-phase connection means, the inventor noticed that in the multi-phase, machine-side connection means between the generator and the converter, the detected surges occur as a result of a non-attenuated series resonance in the zero sequence, in particular as a result of the first series resonance. If means to attenuate this at least one series resonance in the zero sequence of the machine-side connection means are provided, the resonance point in the frequency band is attenuated accordingly and the surges reduced significantly. It has been found that as a result of switching operations of the circuit breakers of the converter in which a broadband spectrum in the frequency domain or steep voltage edges in the time domain are switched on, the series resonance which is not attenuated by the usual dimensioning of the dU/dt filters is stimulated and leads to the surges measures. As a result, an attenuation of this series resonance leads to significantly decreased surges to a value which is permissible for the electrical load on the machine-side connection between the converter and the generator. The invention is particularly effective in terms of the technical effort if the value of the parasitic inductances and capacitances of the machine-side connection between the converter and the generator is significantly higher than assumed for a usual dimensioning of the dU/dt filter.

According to a first embodiment, the means for attenuating the at least one, preferably the first series resonance in the zero sequence of the machine-side connection means has at least one series resistance magnetically coupled into the zero sequence of the machine-side connection means. This series resistance in the zero sequence of the machine-side connection means leads to sufficient attenuation of the series resonance with a relatively low additional loss of power. The loss of power is less than 2 kW for sufficient attenuation where the power output is several megawatts.

The at least one magnetically coupled series resistance in the zero sequence preferably has an electrical resistance R for which the following relationship to determine the attenuation is sensibly defined:

$$R = d * \sqrt{\frac{L}{C}} \qquad ( 1 )$$

wherein L is the inductance and C is the capacitance of the machine-side connection means between the generator and the converter and d is the proportionality factor of the attenuation, wherein the following applies for d:

0.25≤d≤1.8. (2)

Good attenuation of the series resonance is achieved by selecting the series resistance value in line with equation (1) mentioned above taking into account a proportionality factor din the range from 0.25 to 1.8. Corresponding resistance values are for example a maximum of 10Ω, preferably 1 to 5Ω. The at least one magnetically coupled series resistance in the zero sequence of the machine-side connection means is preferably coupled by means of at least one magnetic core so that attenuation of the series resonance of the machine-side connection means is achieved.

According to a further embodiment, the at least one magnetic core preferably surrounds the neutral conductor of the machine-side connection means between the converter and the generator for magnetic coupling of the series resistance. The surrounding of the neutral conductor causes the magnetic core to amplify the magnetic field generated between the converter and the connection means to the generator by means of the flow of current in the zero sequence. Surrounding can also mean that the magnetic core is designed as a ring around the neutral conductor with or without a gap. No high powers or currents are guided by means of the neutral conductor of the machine-side connection means, so the generated magnetic fields and thus also the power losses in the series resistance are low compared to the magnetic fields generated by the currents of the main connection conductors, in other words the power phases. For this reason, the neutral conductor is also generally designed to be small in terms of the geometric dimensions and can be easily surrounded by a magnetic core. The arrangement of the magnetic core to surround the neutral conductor therefore only requires relatively little effort.

If the neutral conductor of the machine-side connection means is designed at least in some areas as cables and/or busbars, the at least one magnetic core can easily be arranged at least in one of these areas to magnetically couple into the series resistance.

According to a first variant of the magnetic coupling, the at least one magnetic core comprises electrical sheet, wherein an air gap is optionally provided to provide a specific magnetic resistance of the magnetic core. In the variant of the magnetic core made of electrical sheet, the frequency range is limited for the current to be transferred, so that the corresponding magnetic core already has an attenuating effect at high frequencies. Due to the magnetic resistance in the region of the air gap, a specific inductance and therefore a specific series resistance is also provided by the magnetic core. In this case, heat loss occurs in the entire magnetic core due to the resonance attenuation. Because of its weight, the magnetic core made of electrical sheet is particularly cost effective to manufacture, easily available, but needs special cooling measures as the heat is released in the entire magnetic core. In addition, its dimensions should be chosen to be larger as compared to other magnetic materials in light of its electrical properties.

According to the second embodiment, the magnetic core consists of another soft magnetic full material, preferably ferrite, wherein the at least one magnetic core has at least one coil, the winding connections of which are connected to one another by means of at least one series resistance. Soft magnetic full materials have low coercive field strengths. The attenuation properties of ferrite are low due to its significantly lower losses as a result of lower coercive field strengths. For this reason a coil is arranged on the soft magnetic core which is connected to a series resistance. A voltage is generated in the coil by the alternating magnetic field in the magnetic core, which voltage leads to a current flow via the series resistance. The attenuation performance of this arrangement can be very carefully adjusted by selecting the number of windings on the coil, usually less than 10, e.g. 2 to 6, and by selecting the series resistance. Hereby the reduction in voltage peak values can be set very precisely according to equation (1).

The resistance of the series resistance is a few Ω, for example a maximum of 10Ω, so that standard components can be used and the costs of the arrangement can be significantly reduced. The attenuation performance is essentially converted into heat via the series resistance. At the same time, the resistance can be precisely matched to the expected attenuation performance and therefore to the expected power loss. Where the loss of power is expected to be low, natural convection can be sufficient to cool the series resistance so that no additional cooling means is required.

If the at least one series resistance is preferably arranged on cooling means according to a further embodiment and optionally variably adjustable in resistance value, even higher power losses can be dissipated safely in the form of heat. A variably adjustable series resistance allows the series resistance to be adapted to various circumstances subsequently on site, e.g. after the construction of a wind turbine, thereby enabling an optimization of the attenuation of the series resonance with simultaneous low losses. The cooling means on which the series resistance is arranged can be designed to be active, for example cooling means with cooling medium flowing through them, or passive, for example merely designed as cooling elements. The dimensioning of these cooling means allows the calculated power loss at the series resistance to be safely dissipated via the cooling means with little effort.

The machine-side connection means are preferably dimensioned such that the series resonance of the connection means in the system is below a frequency of 500 Hz, preferably below a frequency of 150 Hz. The series resonance can approximately be calculated from the equation:

$$ω = \frac{1}{\sqrt{L C}} \qquad ( 3 )$$

The capacitance C and the inductance L of the machine-side connection means result from the geometric dimensions of the machine-side connection means and their arrangement, for example in the tower of the wind turbine. If the series resonances in the zero sequence are below a frequency of 500 kHz or below a frequency of 150 kHz, the resonances cannot be attenuated via the network filters which are usually provided (dU/dt filter). As already mentioned, these operate in a significantly higher frequency band, around 1 MHz. Especially for these low series resonant frequencies, the device according to the invention can provide an effective attenuation of the at least one, preferably the first series resonance with simultaneously low power loss.

The resonance (frequency) which has the lowest resistance, in other words whose oscillations are least attenuated, is designated the first series resonance (frequency). This generally occurs at the resonance with the lowest frequency. All higher series resonances usually also have higher attenuations.

According to a further embodiment of the device, the device is a wind turbine, wherein the wind turbine has a double-fed asynchronous machine or a synchronous generator as a generator. Both generator types are connected to a DC link by means of a machine-side converter and via this to a network-side converter such that the electrical energy provided by the generator can be fed into the electrical supply network in a suitable form. Both types of wind turbine are characterized by the fact that the converters are usually not arranged in the gondola, i.e. in the immediate vicinity of the generator. The converters are therefore connected to the generators on the machine side via long connection means, which can lead to higher parasitic inductances and capacitances. The attenuation of at least one, preferably the first series resonance leads to an improved voltage behavior at the machine-side input into the converter in both system types.

According to further teaching of the present invention, the above-mentioned object is achieved by a method for operating a device for generating electrical energy, in particular a wind turbine, in that at least one, preferably the first series resonance in the zero sequence of the machine-side connection means between the generator and the converter is determined, depending on the series resonance determined a series resistance for attenuating this series resonance is determined and this series resistance is magnetically coupled into the zero sequence.

As already described, the attenuation of the series resonance in the zero sequence via a magnetic coupling of a series resistance enables voltage peaks caused by the parasitic inductances and capacitances of the machine-side connection means at the converter input to be avoided and to be significantly attenuated. At the same time, the method can provide a low power loss as a result of the magnetic coupling of the series resistance.

### BRIEF DESCRIPTION OF THE DRAWINGS

The invention shall be described in greater detail below using embodiments in combination with the figures, in which:

FIG. 1 is a schematic representation of a device for generating electrical energy in the form of a wind turbine,

FIG. 2 is a simulation of the excess voltage caused by a series resonance in a voltage time diagram of a phase against the zero potential on the machine-side input of the converter,

FIG. 3 is an embodiment of a circuit diagram of the connection means from the generator to the converter,

FIGS. 4, 5 are an embodiment of a magnetically coupled series resistance in a sectional view and a plan view and

FIG. 6 is a further embodiment of a magnetically coupled series resistance with a sheet metal magnetic core.

### DETAILED DESCRIPTION

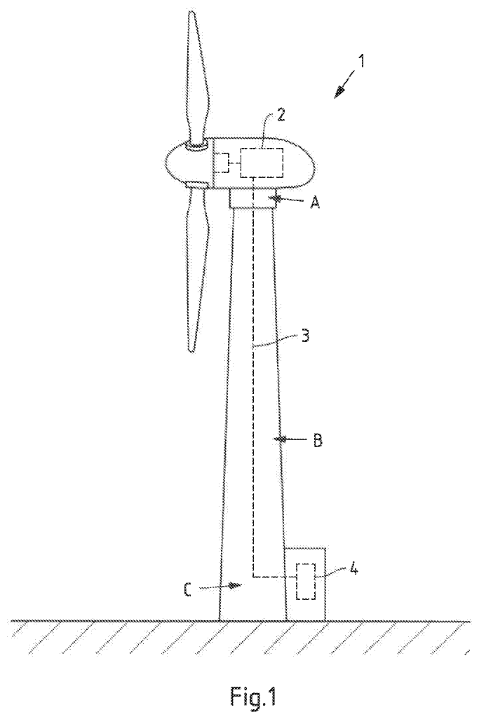

FIG. 1 shows a device for generating electrical energy in the form of a wind turbine 1 having at least one generator 2, wherein the generator provides electrical energy to at least one converter 4 with a DC link via multi-phase, machine-side connection means 3. The connection means 3 shown in FIG. 1 are provided on the machine-side, in other words provided between the generator 2 and the converter 4, and are generally designed to be three-phase. In the present embodiment, the connection means 3 are divided into three sections A, B and C. In areas A and C, the connection means 3 are designed as a cable. In area B, the connection means 3 provided on the machine side are designed as busbars. Busbars differ from cables in that they generally do not have a round cross-sections, but rather square and in particular rectangular cross-sections in order to achieve the advantages of the busbars, i.e. to be easily premountable. Due to the flat extension of the cross-section, they can carry very high currents in a very small space. For example, busbars can easily guide the current at a right angle while cables cannot achieve this due to their high level of rigidity. Pre-assembly, for example in the tower of the wind turbines, is also difficult to achieve with cables. In addition, where the outputs to be carried are high, busbars are also significantly cheaper than cables. A disadvantage of busbars, however, is that due to the geometric cross-sectional shape of the busbars and their arrangement in the tower higher parasitic inductances and capacitances can occur.

The geometric design of the busbars in area B in connection with the cable routing in areas A and C of the machine-side connection means 3 cannot prevent parasitic inductances and capacitances, so that resonances and thus undesirable voltage fluctuations occur in particular in the zero sequence, i.e. the voltage of all phases relative to the zero potential or earth.

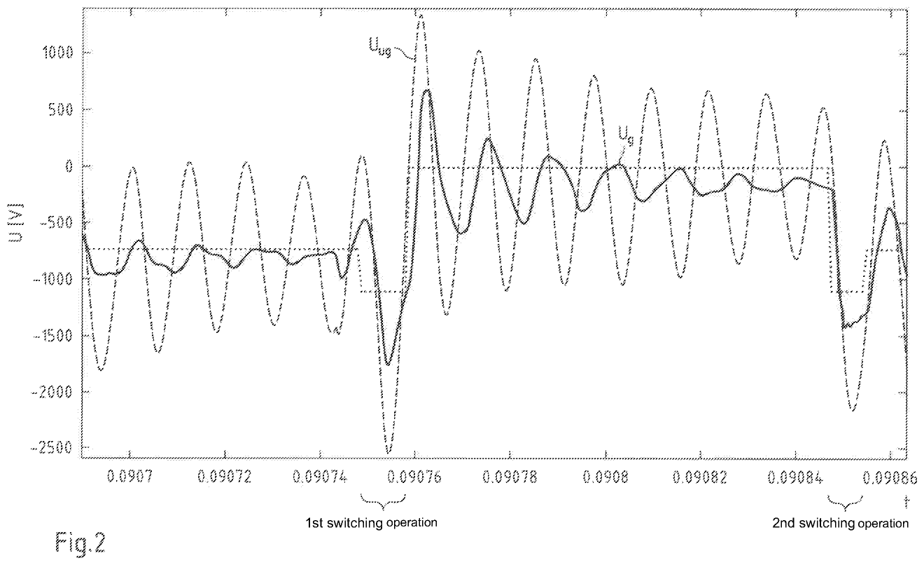

FIG. 2 shows a simulation of the time progression of the voltage in a phase of the converter 4 relative to the zero potential during two switching operations of a circuit breaker of the converter 4. The first and second switch switching operations are ideally carried out in steps. The diagram further shows the unattenuated progression of the voltage U_{ug} as a dashed line and the time progression of the voltage with attenuation of the series resonance U_{ug} as a continuous line.

It can be seen that the unattenuated voltage U_{ug} shows significant overshooting relative to the zero potential during the first switching operation and takes on values of between approximately 1300 V and −2500 V in the case shown. The voltage peaks can, however, be problematic with regard to the components of the converter. Voltage flashovers can cause damage to the converter or to the connection means to the generator.

As already mentioned, the inventor identified that series resonances, in particular the first series resonance in the zero sequence of the multi-phase connection means 3 are the cause of the voltage peaks. If this at least one, preferably the first series resonance in the zero sequence of the machine-side connection means 3 between generator 2 and converter 4 is attenuated via means for attenuating the resonance, there is a significant reduction in the voltage peaks. The correspondly simulated voltage progression U_{g} in FIG. 2 shows that the minimum voltage peak value of U_{g} is only around −1700 V and the maximum peak value is +750 V. The overshooting behavior could be reduced by +900 V or −750 V for this switching operation. If this attenuation is not sufficient, greater attenuation of the voltage overshooting can be achieved by selecting a higher proportionality factor d. The attenuation is preferably selected so that the voltage U_{g} takes on values for which the inputs of the converter and also the connection means are designed, so that no voltage flashovers can occur and damage is prevented. The attenuation of the series resonance is also clearly visible in the second switching operation and shows even smaller voltage peak values. The desired reduction effect on the voltage peak value is set by selecting the magnet material of the core and/or selecting the resistance value and thus via the proportionality factor d; the reduction effect can be seen in FIG. 2 as an example. At the same time, despite the attenuation, the power loss to be accepted is low. It is a maximum of about 2 kW.

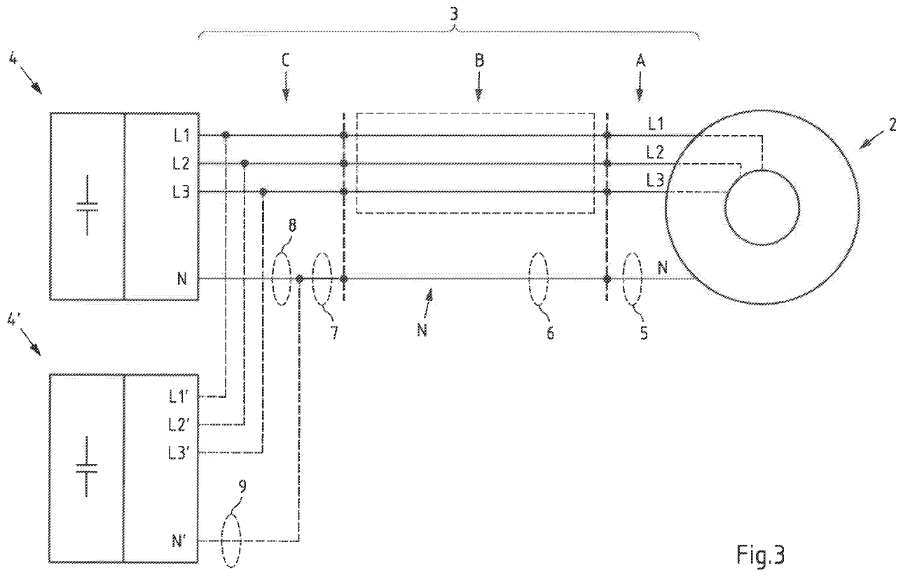

FIG. 3 shows a circuit diagram of the connection means 3 of an embodiment of a device for generating electrical energy, in particular a wind turbine, having a generator 2 and a converter 4 or 4′. The connection means 3 between generator 2 and converter 4 or 4′ are designed to be three-phase L1, L2, L3 or L1′, L2′, L3′. At the same time, the generator 3 is also connected to the converter 4 or 4′ by means of a neutral conductor N or N′. The neutral conductor N, N′ is part of the machine-side connection means 3.

Furthermore, in FIG. 3 the connection means 3 are divided into three areas A, B and C, wherein area B is for example designed as a busbar, for example in the tower of a wind turbine. Areas A and C should for example be designed as cables. Means for attenuating the series resonance of the connection means 3 in the zero sequence 5, 6, 7, 8 and 9 are also shown in FIG. 3, wherein the means shown for attenuating the series resonance 5, 6, 7, 8 and 9 in particular aim to illustrate the various possible positions of the attenuating means. In the present embodiment, the means for attenuating the series resonance in the zero sequence 5, 6, 7, 8 and 9 are designed as series resistances magnetically coupled into the neutral conductor N and symbolized by the annular magnetic core in FIG. 3.

The means for attenuating the series resonance 5, 6, 7, 8 and 9 can be provided in the areas A, B and C of the connection means. If, for example, the neutral conductor N is realized by the metallic tower wall of a wind turbine in area B, the magnetic coupling of the means for attenuating the series resonance cannot occur in this area. In this case, however, another position for the magnetic coupling of a series resistance 5, 7, 8 or 9 can be used for attenuating the series resonance, for example in the cable routing areas A and C. In principle, the cable routing areas A and C of the connection means 3 are preferably selected for the magnetic coupling of the series resistance as the magnetic coupling of the series resistance is easily possible in these areas with relatively small magnetic cores.

As shown in FIG. 3, the generator 3 can also be connected to a further converter 4′ via multi-phase connection means 3, wherein three further phases L1′, L2′ and L3′ and a further neutral conductor N′ provide the electrical connection between the converter 4′ and the generator 3. A means for attenuating the series resonance 9 can additionally be provided in the neutral conductor N′ of the connection means to the converter 4′. In principle, where converters 4 and 4′ are operated in parallel, it is also sufficient to provide a magnetically coupled series resistance 7, 6 or 5 before the branch of the parallel neutral conductor N′ for the converter 4′.

The generator in FIG. 3 is merely shown schematically. This generator 3 can be a synchronous generator, the stator of which is connected to the converters 4 and 4′. The generator 3 can, however, also be designed as a double-fed asynchronous machine so that the generator 2 is connected to the converter 4 or 4′ on the rotor side via multi-phase connection means 3. In order to indicate this, the phases L1, L2 and L3 at the generator 3 are dashed lines to the rotor.

The at least one magnetically coupled series resistance in the zero sequence of the circuit diagram in FIG. 3 with reference signs 5, 6, 7, 8 or 9 has an electrical resistance for which the following is defined:

$$R = d * \sqrt{\frac{L}{C}} \qquad ( 1 )$$

wherein L is the inductances and C is the capacitance of the machine-side connection means between generator and converter, d is the proportionality factor of the attenuation. For values of d in the range of 0.25 to 1.8, the magnetically coupled series resistance value is high enough for the series resonance in the zero sequence of the connection means designed to be multi-phase to be able to be attenuated very well. As already mentioned, resistance values of less than 10Ω, preferably 1 to 5Ω, are preferably used.

The position of the means for attenuating the series resonance, for example the position of the magnetic core for coupling the series resistance, can be arranged in the various areas A, B or C of the multi-phase connection means 3 depending on the circumstances. Since the neutral conductor N or N′ is not designed for the transmission of large amounts of energy, it has smaller geometric dimensions than the remaining power phases. The arrangement of a magnetic core on the neutral conductor can therefore be achieved in a simple manner. In areas B and C this occurs, as mentioned, in a particularly simple manner as the neutral conductor N or N′ is designed as a cable. However, it is also conceivable for attenuation means to be provided in several areas A, B and C.

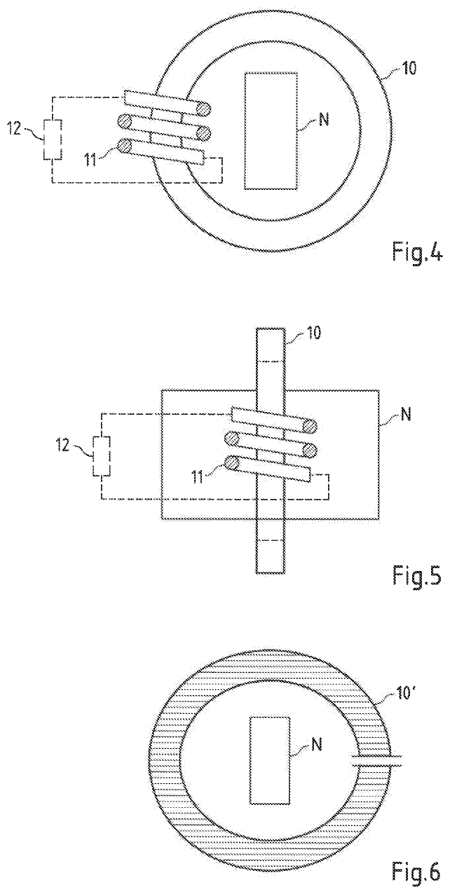

FIG. 4 and FIG. 5 show a magnetic core of soft magnetic full material 10, preferably ferrite, which surrounds a neutral conductor N and has at least one coil 11 which is connected or short-circuited via at least one series resistance 12. While FIG. 4 shows a sectional view perpendicular to the longitudinal axis of the neutral conductor N, FIG. 5 is a planar view of the neutral conductor N. The soft magnetic ring 10 surrounds the neutral conductor N perpendicular to its longitudinal extension. The alternating magnetic field induced in the magnetic core generates a voltage in the coil 11 which leads to a current flow via the series resistance 12. The magnetic core 10 made of soft magnetic full material, in particular ferrite, only has very low heat losses caused by the induction of magnetic alternating fields in the magnetic core so that the heat loss in the soft magnetic, for example ferrite, ring remains low. In the series resistance 12, the heat loss is substantially released due to the attenuation of the series resonance.

The series resistance 12 is therefore preferably arranged on cooling means not shown, which ensure the safe release of heat in a simple manner. The use of a ferrite core 10 has the advantage that the heat loss resulting from the attenuation of the series resonance can be transferred to cooling means in a targeted manner. Furthermore, an optimized attenuation behavior relative to the series resonance to be attenuated can be set by selecting the series resistance in the resistance value as well as by means of the number of windings of the coil on the magnetic core. The number of windings is preferably fewer than 10, particularly preferably 2 to 6 windings.

The series resistance shown in FIG. 4 and FIG. 5 can preferably be adjusted in a variable manner in its resistance value. This has the advantage that, for example, at the site of installation of a wind turbine, an optimized attenuation of the series resonance can still be set after the installation. The same applies in the case of a retrofitting of an existing device for generating electrical energy.

A further, simple option for coupling a series resistance magnetically into the zero sequence is shown in a schematic sectional view in FIG. 6. Here, a magnetic core 10′ consisting of electrical sheet is shown. The magnetic core has a defined gap so that a defined magnetic resistance can be set. The neutral conductor which is surrounded by the magnetic core 10′ is also shown.

The magnetic core 10′ itself constructed in this way already provides the series resistance in which the magnetic resistance leads to heat loss and therefore to an attenuation of the series resonance during the change of the magnetization direction due to the series resonance. The resulting heat loss is released in the entire magnetic core 10′ and in this case must be sufficiently well dissipated. The advantage of the sheet metal magnetic core 10′ is that it is cost-effective and its geometric shape can be relatively freely selected.

The device shown in FIG. 3 can be used particularly effectively if the series resonance of the connection means in the zero sequence is below 500 kHz, preferably below 150 kHz. These frequency ranges are not attenuated by the network filters (dU/dt filters) usually provided in wind turbines. The device shown in FIG. 3 provides very good attenuation of the series resonance in the zero sequence of the connection means 3.

The device for generating electrical energy, particularly the wind turbine, is preferably operated such that initially at least one series resonance in the zero sequence of the machine-side connection means 3 between generator 2 and converter 4, 4′ is determined, for example after their assembly or even in advance by means of a simulation, and a series resistance 5, 6, 7, 8, 9 is magnetically coupled into the zero sequence of the connection means 3 depending on the series resonance determined. Surges induced on the machine side by the switching behavior of the converters in the zero sequence are significantly suppressed in this way and an improved switching behavior of the converters is achieved.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A device for generating electrical energy, in particular a wind turbine, comprising:
at least one generator, wherein the generator provides electrical energy via multi-phase, machine-side connection means and is connected to at least one converter having a DC link via the multi-phase, machine-side connection means,
wherein means for attenuating at least one series resonance in the zero sequence of the machine-side connection means are provided between generator and converter.

2. The device according to claim 1, wherein the means for attenuating the series resonance in the zero sequence have at least one magnetically coupled series resistance effective for the zero sequence of the machine-side connection means.

3. The device according to claim 1, wherein the at least one magnetically coupled series resistance in the zero sequence has an electrical resistance R for which the following applies:
$$R = d * \sqrt{\frac{L}{C}} \qquad$$
wherein L is the inductance and C is the capacitance of the machine-side connection means between generator and converter and d is the proportionality factor of the attenuation, and the following applies for d:
0.25≤d≤1.8.

4. The device according to claim 1, wherein the at least one magnetically coupled series resistance in the zero sequence of the machine-side connection means is coupled by means of at least one magnetic core.

5. The device according to claim 4, wherein the at least one magnetic core surrounds the neutral conductor of the machine-side connection means between converter and generator for the magnetic coupling of the series resistance.

6. The device according to claim 5, wherein the neutral conductor of the machine-side connection means is designed at least in some areas as cables and/or busbars and wherein the at least one magnetic core is arranged in at least one of these areas.

7. The device according to claim 4, wherein the at least one magnetic core is made of electrical sheet, wherein an air gap is optionally provided to provide a specific magnetic resistance of the magnetic core.

8. The device according to claim 4, wherein the at least one magnetic core is made of soft magnetic full material, preferably ferrite, wherein the at least one magnetic core has at least one coil, the winding connections of which are connected to one another by means of at least one series resistance.

9. The device according to claim 1, wherein the at least one series resistance is arranged on cooling means and can optionally be variably adjusted in terms of its resistance value.

10. The device according to claim 1, wherein the machine-side connection means are dimensioned such that the series resonance of the connection means in the zero sequence occurs below 500 kHz, preferably below 150 kHz.

11. The device according to claim 1, wherein the device is a wind turbine, wherein the wind turbine as a generator has a double-fed asynchronous machine or a synchronous generator.

12. A method for operating a device for generating electrical energy, in particular a wind turbine according to claim 1, comprising the step of:
determining at least one series resonance in the zero sequence of the machine-side connection means between generator and converter,
determining a series resistance for attenuating this series resonance depending on the series resonance determined, and
magnetically coupling this series resistance into the zero sequence.
